(19) United States
(12) Patent Application Publication
(10) Pub. No.: US 2026/0180762 A1
(43) Pub. Date: Jun. 25, 2026

(54) ADAPTATION OF A CHANNEL STATE INFORMATION (CSI) TRAINING MODEL

(71) Applicant: Lenovo (Singapore) Pte. Ltd., Singapore (SG)

(72) Inventors: Vahid POURAHMADI, München (DE); Venkata Srinivas KOTHAPALLI, Aurora, IL (US); Ahmed HINDY, Aurora, IL (US); Vijay NANGIA, WOODRIDGE, IL (US)

(21) Appl. No.: 19/126,042

(22) PCT Filed: Nov. 1, 2023
(86) PCT No.: PCT/IB2023/061018

§ 371 Date: Apr. 30, 2025

Related U.S. Application Data
(60) Provisional application No. 63/382,050, filed on Nov. 2, 2022.

(51) Int. Cl. H04L 5/00; H04W 24/10

(52) U.S. Cl. CPC H04L 5/0053; H04L 5/0057; H04W 24/10

(57) ABSTRACT

Various aspects of the present disclosure relate to adapting CSI feedback models in wireless networks. For example, an AI/ML model can suffer from degradation when observation sample data fed into the model are different than the training data used to train the model. Thus, various techniques to monitor the performance of the model and/or update the model when degradation is detected, can enhance use of the model when performing CSI feedback tasks. The techniques can be deployed at a UE side of the network, such as directed to input data or a latent representation of input data, which can minimize the overhead placed on the network during a model update.

### CROSS REFERENCE TO RELATED APPLICATIONS

This application claims priority to U.S. Provisional Patent Application No. 63/382,050, filed on Nov. 2, 2022, entitled ADAPTATION OF A CHANNEL STATE INFORMATION (CSI) TRAINING MODEL, which is hereby incorporated by reference in its entirety.

### TECHNICAL FIELD

The present disclosure relates to wireless communications, and more specifically to CSI (channel state information) feedback models in a wireless communications system.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A network entity (e.g., a gNB) often employs associated UEs to monitor a channel or communication link between devices, where the UEs monitor and collect information (e.g., feedback) for the channel on behalf of the gNB. In some cases, the UEs and the network entity utilize various Artificial Intelligence (AI) or Machine Learning (ML) models to assist in generating CSI feedback for a channel or other communication link of the network.

### SUMMARY

The present disclosure relates to methods, apparatuses, and systems that support adapting CSI feedback models in wireless networks. For example, an AI/ML model can suffer from degradation when observation sample data fed into the model are different than the training data used to train the model. Thus, various techniques to monitor the performance of the model and/or update the model when degradation is detected, can enhance use of the model when performing CSI feedback tasks. The techniques can be deployed at a UE side of the network, such as directed to input data or a latent representation of input data, which can minimize the overhead placed on the network during a model update.

Some implementations of the method and apparatuses described herein may further include a first device, comprising a processor and a memory coupled with the processor, the processor configured to cause the first device to determine a first parameter for a model update of an AI/ML model trained to determine CSI feedback for a channel of a network, determine a first set of information including a first set of channel data representations during a first time-frequency-space region and a second set of information including a second set of channel data representations during a second time-frequency-space region, determine, based at least in part on the first set of information and the second set of information, a set of parameters for a first model, generate a third set of information based at least in part on the first model and a first data input to the first device, and transmit the third set of information to a network entity.

In some implementations of the method and apparatuses described herein, the first data input to the first device is based on a channel data representation.

In some implementations of the method and apparatuses described herein, the channel data representation is determined based on reception by the first device of at least one reference signal from the network entity.

In some implementations of the method and apparatuses described herein, the channel data representation is based on different Tx-Rx pairs over different frequency bands, different time slots, or transformation of the Tx-Rx pairs in a domain.

In some implementations of the method and apparatuses described herein, the first parameter includes a periodicity, and the set of parameters is periodically determined based on the periodicity.

In some implementations of the method and apparatuses described herein, the processor is further configured to determine the first parameter based on a signal received from the network entity and determine the set of parameters in response to receiving the first parameter.

In some implementations of the method and apparatuses described herein, the processor is further configured to determine the first parameter based on the first data.

In some implementations of the method and apparatuses described herein, the processor is further configured to determine the first parameter based on the first set of information and the second set of information.

In some implementations of the method and apparatuses described herein, the set of parameters includes a structure of a neural network or weights of a neural network.

In some implementations of the method and apparatuses described herein, the processor is further configured to determine the set of parameters when an output of the first model based on the second set of information satisfies a similarity measure with respect to the first set of information.

In some implementations of the method and apparatuses described herein, the similarity measure is determined using a cycle-consistent generative adversarial network (CycleGAN).

In some implementations of the method and apparatuses described herein, the first set of information includes training data for training a two-sided model, wherein the two-sided model includes a second model and a third model.

In some implementations of the method and apparatuses described herein, the third set of information is based further on the second model of the two-sided model.

In some implementations of the method and apparatuses described herein, the processor is further configured to determine the set of parameters when an output of the first model based on the second set of information satisfies a similarity measure with respect to an output of the second model based on the first set of information.

In some implementations of the method and apparatuses described herein, the processor is further configured to initialize the set of parameters with a second set of parameters associated with the second model of the two-sided model.

In some implementations of the method and apparatuses described herein, the similarity measure includes a statistical divergence measure that is lesser than a predetermined threshold.

In some implementations of the method and apparatuses described herein, the processor is further configured to determine a set of parameters for a fourth model, and determine the similarity measure based on the fourth model.

In some implementations of the method and apparatuses described herein, the processor is further configured to determine the set of parameters when an output of the second model based on the first set of information satisfies a similarity measure with an output of a concatenated first model and second model based on the second set of information.

In some implementations of the method and apparatuses described herein, the similarity measure includes a statistical divergence measure that is lesser than a predetermined threshold.

In some implementations of the method and apparatuses described herein, the processor is further configured to determine a set of parameters for a fourth model, and determine the similarity measure based on the fourth model.

In some implementations of the method and apparatuses described herein, the processor is further configured to determine the first parameter based on the first model and the second model.

In some implementations of the method and apparatuses described herein, the first device is user equipment (UE).

In some implementations of the method and apparatuses described herein, the first set of information is a training dataset and the second set of information is an observation dataset.

In some implementations of the method and apparatuses described herein, the third set of information is feedback CSI data generated by the AI/ML model and the first data is data measured by the first device and input to the AI/ML model.

In some implementations of the method and apparatuses described herein, the set of parameters for the first model include weights of an adaptation model of the AI/ML model.

In some implementations of the method and apparatuses described herein, the processor is configured to cause the first device to determine the set of parameters for the first model in response to the first parameter satisfying criteria associated with performing the model update.

In some implementations of the method and apparatuses described herein, the first set of information is received from the network entity via network signaling.

In some implementations of the method and apparatuses described herein, the first set of information is received from a second device.

Some implementations of the method and apparatuses described herein may further include a method performed by a first device, the method comprising determining a first parameter for a model update of an AI/ML model trained to CSI feedback for a channel of a network, determining a first set of information including a first set of channel data representations during a first time-frequency-space region and a second set of information including a second set of channel data representations during a second time-frequency-space region, determining, based at least in part on the first set of information and the second set of information, a set of parameters for a first model, generating a third set of information based at least in part on the first model and a first data input to the first device, and transmitting the third set of information to a second device.

Some implementations of the method and apparatuses described herein may further include a network entity, comprising a processor and a memory coupled with the processor, the processor configured to cause the network entity to transmit a first set of information to a first device, receive, from the first device, a second set of information, and generate an output based on the second set of information and a first model.

In some implementations of the method and apparatuses described herein, the first set of information includes a set of channel data representations used for training a two-sided model that includes the first model and a second model.

In some implementations of the method and apparatuses described herein, the channel data representation is based on a reference signal received from the UE.

Some implementations of the method and apparatuses described herein may further include a method performed by a network entity, the method comprising transmitting a first set of information to User Equipment (UE), receiving, from the UE, a second set of information, and generating an output based on the second set of information and a first model.

In some implementations of the method and apparatuses described herein, the first set of information includes a set of channel data representations used for training a two-sided model that includes the first model and a second model.

### BRIEF DESCRIPTION OF THE DRAWINGS

FIG. 1 illustrates an example of a wireless communications system that supports CSI feedback models in accordance with aspects of the present disclosure.

FIGS. 2A-2B illustrate examples of diagrams that support a two-sided model deployed between a UE and a network entity in accordance with aspects of the present disclosure.

FIG. 3 illustrates an example of a diagram that supports input-based model adaptation in accordance with aspects of the present disclosure.

FIGS. 4-5 illustrate examples of diagrams that support latent space-based model adaptation in accordance with aspects of the present disclosure.

FIG. 6 illustrates an example of a block diagram of a device that supports encoding time and/or angle information of incidence angles during radio sending operations in accordance with aspects of the present disclosure.

FIG. 7 illustrates a flowchart of a method that supports updating an AI/ML model in accordance with aspects of the present disclosure.

FIG. 8 illustrates a flowchart of a method that supports generating CSI feedback using an updated AI/ML model in accordance with aspects of the present disclosure.

### DETAILED DESCRIPTION

For wireless communications systems having a large number of antennas and/or large frequency bands, a network entity (e.g., gNB) may request large amounts of feedback (e.g., CSI feedback) from associated UEs. To handle such large amounts, the wireless communications system can employ AI/ML models that are trained to determine certain channel characteristics (e.g., data rates) for a channel using a relatively small amount of actual data captured by the UEs.

However, AI/ML models are data driven and their performance when configured as CSI feedback models can degrade when statistics of data input into the models (e.g., input data) vary. Various schemes have attempted to improve the performance of these AI/ML models.

As a first example, a model switching scheme entails the construction of different models for different channel characteristics. The network selects one of the models based on current statistics of a channel or associated environment. However, the training/storing of multiple models introduces complexity and issues related to model selection and construction before or during channel monitoring occurs.

As another example, a fine-tuning scheme seeks to improve weights of an AI/ML model after detection of degradation of an employed model. While the scheme can enhance an employed model by matching weights to new statistics, there are drawbacks associated with starting new model training sessions using the new weights, such as undesirable complexity and overhead being applied to the network during the new sessions.

Therefore, it is desirable for a wireless communications system to perform AI/ML model updates with a reduced overhead to a network, as well as monitor performance of deployed models (e.g., models deployed to collect and determine CSI feedback for a channel) in and efficient manner, among other benefits. For example, the techniques can be deployed at a UE side of the network, such as being directed to input data or a latent representation of input data, which can minimize the overhead placed on the network during a model update.

Aspects of the present disclosure are described in the context of a wireless communications system. Aspects of the present disclosure are further illustrated and described with reference to device diagrams and flowcharts.

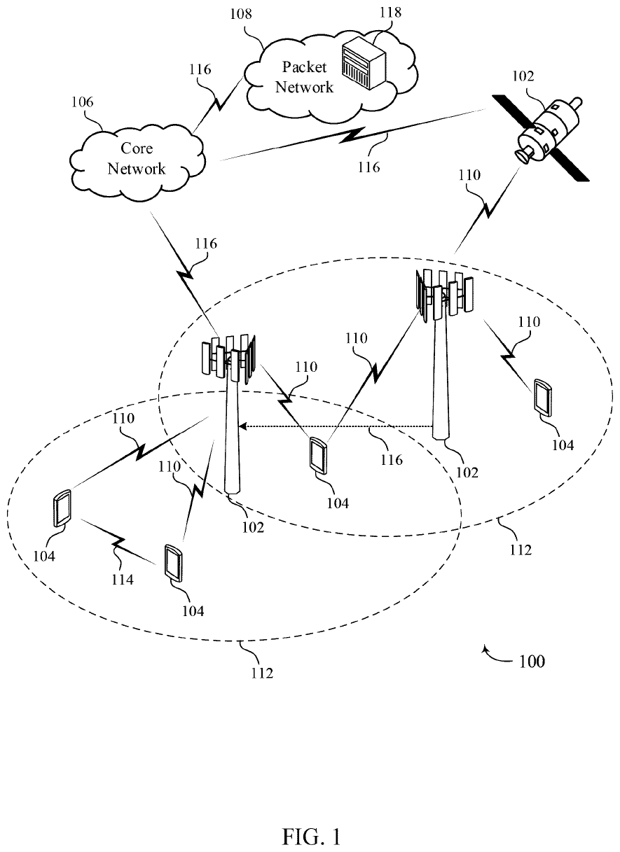

FIG. 1 illustrates an example of a wireless communications system 100 that supports CSI feedback models in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHZ), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

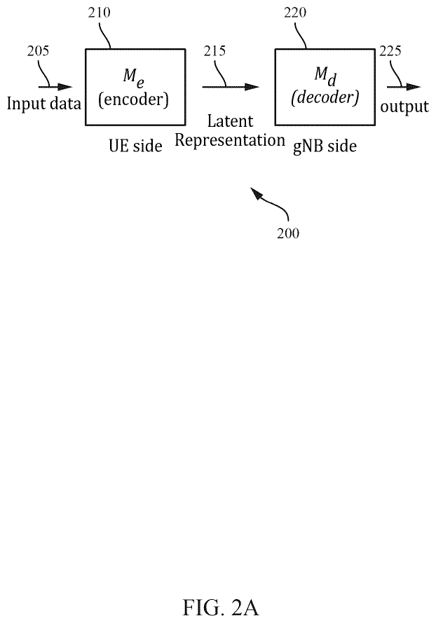

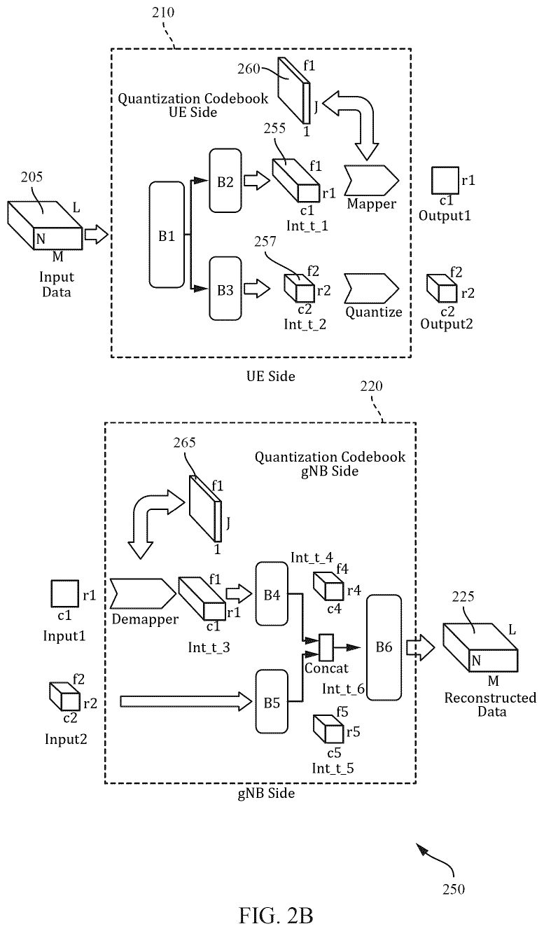

As described herein, the wireless communications system 100 supports the implementation of a two-sided model amongst various devices or entities of a network. FIG. 2A illustrates an example of a diagram 200 that supports a two-sided model deployed between a UE and a network entity in accordance with aspects of the present disclosure.

Given a wireless network having a gNB represented by a node B₁ equipped with M antennas, and K UEs denoted by U₁, U₂, . . . , Uₖ, where each has N antennas,

$${H}_{l}^{k} ( t )$$

denotes the channel at time t over frequency band [symbol] , [symbol] ∈{1, 2, . . . , L}, between B₁ and Uₖ which is a matrix of size N×M with complex entries

$$( e . g . , {H}_{l}^{k} ( t ) ∈ {ℂ}^{N \times M} ) .$$

As an example, at time t and frequency band [symbol] , the gNB wants to transmit message

$${x}_{l}^{k} ( t )$$

to user Uₖ, where k={1, 2, . . . , K} while it uses

$${w}_{l}^{k} ( t ) ∈ {ℂ}^{M \times 1}$$

as a precoding vector. The received signal at Uₖ,

$${y}_{l}^{k} ( t ) ,$$

can then be written as:

$${y}_{l}^{k} ( t ) = {H}_{l}^{k} ( t ) {w}_{l}^{k} ( t ) {x}_{l}^{k} ( t ) + {n}_{l}^{k} ( i ) , where {n}_{l}^{k} ( i )$$

represents the noise vector at the receiver.

The gNB may then select a

$${w}_{l}^{k} ( t )$$

that maximizes a received SNR (signal-to-noise ratio) to improve the achievable rate of the link or channel using various schemes that utilize knowledge of

$${H}_{l}^{k} ( t ) .$$

For example, the gNB can obtain information about

$${H}_{l}^{k} ( t )$$

by direct measurement or indirectly using information from various UEs, as described herein. The AI/ML models can then determine channel characteristics using the information received from the UEs, where the network reduces the rate of feedback provided by the UEs to reduce the overhead on the network.

For example, the AI/ML models can employ two-sided methods, where a first part is deployed at a UE side of the network and a second part is deployed at a network entity (e.g., gNB) side. The UE and gNB sides include one or a few NN (neural network) blocks that are trained using data driven approaches. The UE side computes latent representations of input data (the data that is to be transferred to the gNB) with as low number of bits as possible. The gNB side reconstructs the information intended to be transmitted to the gNB using the latent representations.

FIG. 2A depicts such a two-sided model, where input data 205 is received by an NN-based UE 210, denoted as Mₑ (e.g., an encoding model), and a latent representation 215 of the input data 205 is transferred to a gNB side 220, denoted as M_{d} (e.g., a decoding model), which generates an output 225 of the model, such as a determination of the CSI feedback for the channel. The exact structure, such as which devices deploy aspects of model, at the UE side 210 and/or the gNB 220 side can vary depending on the employed scheme.

In some embodiments, the input data 205 can be based on a channel data representation. The channel data representation, in some cases, can be determined by a reference signal received by the UE, such as from the network gNB, and can be based on different Tx-Rx pairs over different frequency bands, different time slots, and/or transformation of the Tx-Rx pairs in a domain.

In some cases, the UE side 210 sends the latest H^{k} [n,m, [symbol] ] (t) to the gNB side 220. However, in other cases, one or a few eigenvectors associated with the channel state can be transferred. For example, as depicted in FIG. 2B, the Mₑ first generates two latent representations 215 of the input data 205 (e.g., Int_t_1 255 and Int_t_2 257). The Mₑ then quantizes the latent representations 215 using vector and scaler quantization methods, respectively. The UE side 210 transmits the result to the gNB side 220, where the M_{d} tries to generate the desired output 225 (e.g., reconstruction of the input data). Further, for the two-sided model, a Quantization Codebook 260, 265 for both the UE side 210 and the gNB side 220 can be the same, with their value along the weights of the NNs (for all blocks) learned during a training phase. Other hyperparameters (e.g., the value of) and the number of quantization levels (Q) for the “Quantizer block”) can be set during the training phase.

The training phase of the NN modules can include various methods, including centralized training, simultaneous training and/or separate training, and updating the two-sided model can be done centrally on one entity, on different entities but simultaneously, and/or separately.

The technology described herein, in some cases, is based on an already trained AI/ML model, where the UE side 210 and the gNB side 220 are using Mₑ and M_{d} for determining CSI feedback information. The technology, therefore, may constantly and/or consistently monitor the performance of the model, and then update the model in response to various determinations, using low-overhead approaches.

In some embodiments, the two-sided model, or [symbol] , includes Mₑ, or the UE side 210, and M_{d}, or the gNB side 220. In some cases, the technology may employ a one-sided model, where the model is implemented at the UE side 210 (with M_{d} being an identity network). Further, in some cases, the gNB side 220 can act as the encoder and the UE side 210 can act as the decoder.

Further, as described herein, the technology is based on an already trained mode, where a group of UEs use the same model (e.g., the same Mₑ and M_{d} are used for encoding and decoding of the input data), the M_{d} module at the gNB side 220 is the same for a group of UEs, but each UE in that group can have different UE part (e.g., Mₑ), and/or each UE has its own model (e.g., one pair of Mₑ and M_{d} for each UE). In general, the parameters of the UE side 210 are known to or transmitted to each UE and the parameters of the gNB side 220 are known to or transmitted to the gNB or other network entity.

A dataset (or portion of the dataset) for training the model can be denoted as D, where f_{D} represents the distribution of the training dataset. Further, the model operates in an environment where the samples are drawn from an observation dataset S, with a distribution denoted by f_{S}.

For example, a training dataset, or D is collected when the noise power is at N₀, while the observation dataset, or S, is collected from the environment with a noise power N₁. Thus, the two-sided model may exhibit degradation when fed the observation dataset, because f_{S} is different than f_{D}. The model, therefore, can be modified to utilize observable samples and other observation data that differs from training datasets used to train the model. Such a model can avoid or minimize degradation, as well as be monitored/updated without collaboration at both sides of the model, because it is computed at the UE side 210, among other benefits.

In some embodiments, the technology employs input-based schemes which utilize current input data s∈S and the samples collected for model training x∈D to monitor the model and perform model adaptation. For example, statistics associated with currently observed data can vary significantly from the statistics associated with the training data, which can trigger a model update. The model update can include an update to one or more collection parameters, such as parameters of the NN blocks at the UE side 210 and/or the gNB side 220, the periodicity of collecting data, and so on.

A UE, having access to the training dataset D, can collect enough samples from the environment to construct the observation dataset S. The technology can compute or otherwise determine a statistical similarity between the two datasets using different statistical divergence metrics, such as Maximum Density Divergence (MDD) and/or Wasserstein Divergence.

In some embodiments, the technology employs an input-based model adaptation scheme, constructing a function G(.), which generates a modified sample ŝ=G(s) when s is a sample from the observation dataset (i.e., s∈S). The function G(.) is constructed such that a set of modified samples, i.e., Ŝ={ŝ|ŝ=G(s),s∈S} have empirical distribution (denoted by f_{Ŝ}), which is more similar to f_{D} compared to the similarity between f_{S} and f_{D}. The function G(.), in some cases, can be an adaptation function.

The network can employ any network node (e.g., a UE 104 or base station 102) that has access to the training dataset and collected samples (and/or receives the data via network signaling) to construct the function G(.) (although any constructed function may be later transferred to a UE). An example construction process can include the following steps:
Collect (receive) some samples from the current state (observation dataset);
Model G(.) as a parametric function with some initial values;
Repeat the following steps until conveyance;
Use the current estimation of G(.) to produce the modified samples of the observation dataset;
Use the set of modified samples to estimate the statistics of the set of modified samples;
Compare the resulting statistics with the statistics of the training dataset; and/or
Update the parameters of the G(.) function to better match the statistics of the set of modified samples and statistics of the training dataset.

Once constructed, the technology utilizes the trained function G(.) before feeding input data to the model. For example, before obtaining or collecting a new sample from the environment, sₜ, the model goes through an adaptation function to generate a modified sample, [symbol] =G (sₜ). The modified sample, then, is the data input to the encoder model, Mₑ, and the feedback data is constructed as, Mₑ (G(Sₜ)).

Thus, using such a scheme, the M_{d} is not modified or changes (e.g., the complete two-sided model is not updated), which facilitates less overhead and fewer delays within the network for the model update, as the changes/updates occur only at the UE side 210.

In some embodiments, various methods can both construct the adaptation function, G(.), and determine the similarity of f_{S} and f_{D}. For example, schemes based on adversarial networks (e.g., CGAN (conditional generative adversarial network or CycleGAN (cycle-consistent generative adversarial network) can perform both functions. In CycleGAN, G(.) is modeled using a Neural Network (NN) block and the function parameters are in fact the weights of the NN.

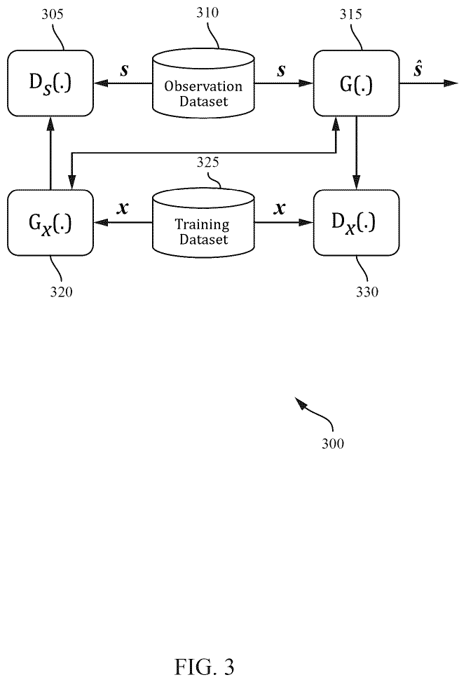

FIG. 3 illustrates an example of a diagram 300 that supports input-based model adaptation (e.g., using CycleGan) in accordance with aspects of the present disclosure.

To train G(.) 315, CycleGAN uses three other NN blocks of Gₓ(.) 320, Dₓ(.) 330, and Dₛ(.) 305, which represent:
Gₓ(.): A generator function that gets samples from training dataset 325 or G(.), and produces samples that have statistics similar to an observation dataset 310;
Dₓ(.): A discriminator function that aims to separate the sample of the training data and samples generated by G(.) to be similar to the training data; and
Dₛ (.): A discriminator function that aims to separate the sample of the observation data and samples generated by Gₓ(.) to be similar to the observation data.

The NN blocks are designed simultaneously, such that G(.) 315 attempts to generate samples using the observation samples and also samples generated by Gₓ(.) 320, where Dₓ(.) 330 cannot differentiate the samples against actual training samples. At the same time, Gₓ(.) 320 attempts to generate samples using the training samples and also samples generated by G(.) 315, such that Dₛ(.) 305 cannot differentiate the samples against observation samples.

In some embodiments, the technology monitors and/or updates a model based on the latent representation of the input data (e.g., instead of s∈S and x∈D, the technology compares the statistics of Mₑ(s) and Mₑ(x)). In some cases, the latent dataset can be constructed based on the last layer of Mₑ and M_{d} and/or based on other layers. Thus Mₑ, in some cases, can refer to a whole UE part or any part of the UE (e.g., from the input layer up to a certain layer). Further, the portion of Mₑ used to determine the latent representation can configured by/reported to another nodes (e.g., a network entity).

In some embodiments, the technology employs latent space-based model monitoring, where the technology attempts to determine a similarity between a latent representation of the inputs (like the processes described herein). For example, such a scheme can be useful when the observed samples and the training samples have different statistics but are otherwise similar for a portion of data associated with an intended task.

To perform latent-space model monitoring, a UE 104 (or a UE node charged with model monitoring) constructs two latent dataset of Lₛ={Mₑ(s)|,s∈S} and Lₓ={Mₑ(x)|,x∈D}. The monitoring function, then, can use various methods for determining the similarity between the statistics of two sets (e.g., MDD, Wasserstein divergence).

The technology, as described herein, can also employ latent-space model adaptation, which modifies how the latent representation is generated for the observation samples, such that the generated latent representation is statistically more similar to the latent representation of the training samples.

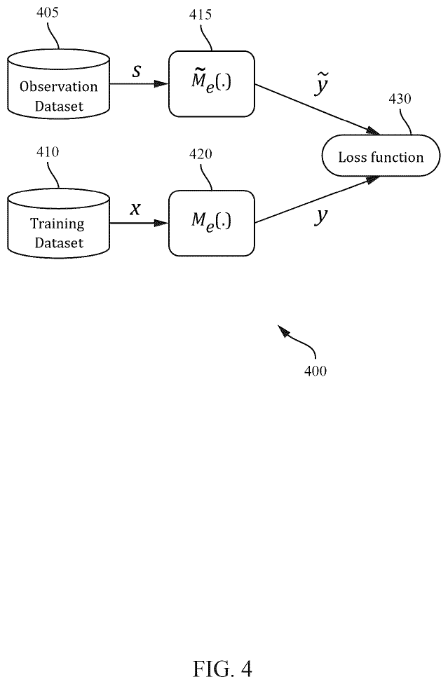

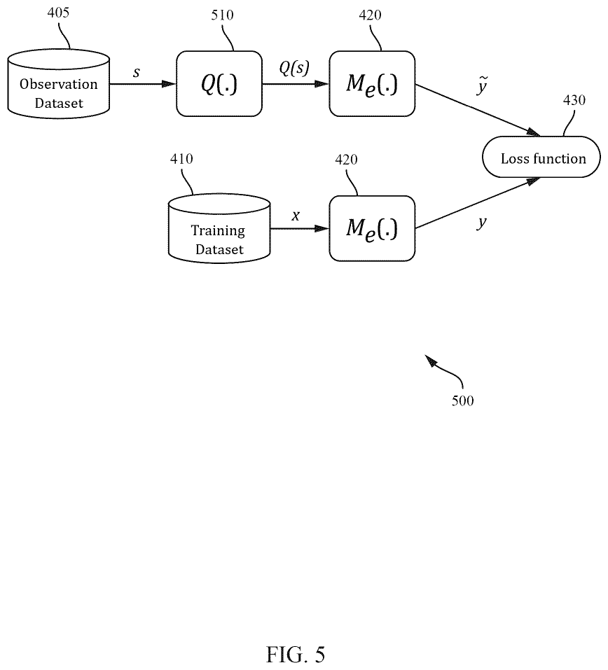

FIGS. 4-5 illustrate examples of diagrams 400, 500 that support latent space-based model adaptation in accordance with aspects of the present disclosure. The diagrams 400, 500 depict methods that increase the similarity between the latent representations of the training and observed samples. As described herein, a UE or UE side 210 node that employs a model update task or procedure can access and/or receive the training dataset and sample dataset (e.g., constructed from observation samples). For example, the trained Mₑ can determine the latent representation of the training samples y=Mₑ(x).

Referring to FIG. 4, the scheme 400 uses the model structure of Mₑ to construct a latent representation of the observation sample \tilde{y}. For example, a Mₑ(.) function 420 receives a training dataset 410 and constructs a latent representation y of a sample x, and a modified \tilde{M}ₑ(.) function 415 receives an observation dataset 405 and constructs the latent representation \tilde{y} of the observation sample S.

The node computes or otherwise determines a loss function 430 using the samples of y and \tilde{y}. The loss function 430 may be the statistical divergence between the samples of y and \tilde{y}. For example, the model adaption is carried out by modifying the weights of the Mₑ block 420 on the top branch (e.g., \tilde{M}ₑ 415) such that the loss function 430 is minimized. After convergence, \tilde{M}ₑ 415 can be used to construct the CSI feedback data.

FIG. 5 depicts a similar scheme 500 to the scheme 400 depicted in FIG. 4. However, an adaptation block Q(.) 510 generates modified samples before feeding data to the Mₑ function 420. The loss function 430, then, is a statistical divergence between the samples of y and \tilde{y}. Thus, model adaption is carried out by modifying the weights of the Q(.) block 510 such that the loss function 430 is minimized. After convergence, Q(.) 510 and Mₑ 420 can be used sequentially to generate the CSI feedback data from the observation samples.

In some embodiments, the technology can employ a discriminator block instead of the loss function 430. For example, the discriminator block can be implemented using a NN block such as L(.).

In some cases, similar to the scheme 400, the L(.) is trained to differentiate samples generated by Mₑ(x) and \tilde{M}ₑ(s), and \tilde{M}ₑ will be trained to generated samples \tilde{y} that are similar to Mₑ(x) or y such that L(.) cannot recognize or differentiate between y and \tilde{y}. After convergence, \tilde{M}ₑ can be used to construct of the CSI feedback data.

In some cases, similar to the scheme 500, the L(.) and the Q(.) 510 are trained simultaneously such that Q(.) 510 attempts to generate samples of Mₑ(Q(s)) as close as possible to Mₑ(x), and L(.) attempts to differentiate between Mₑ(x) and Mₑ(Q(s)). After convergence, Q(.) and Mₑ can used sequentially to generate the CSI feedback data from the observation samples.

Thus, in some embodiments, the technology utilizes various techniques to monitor/update AI/ML two-sided models associated with CSI feedback transmission within a network. The techniques can include an input-based model monitoring, a model adaptation schemes having no communication with the network, a model monitoring scheme using the latent-space of the input data, a model adaptation scheme based on statistical divergence loss function and/or a discriminator block that uses the statistics of the latent representation of the input data, and other methods or schemes that perform monitoring and updates without introducing complexity or overhead to the network, among other benefits.

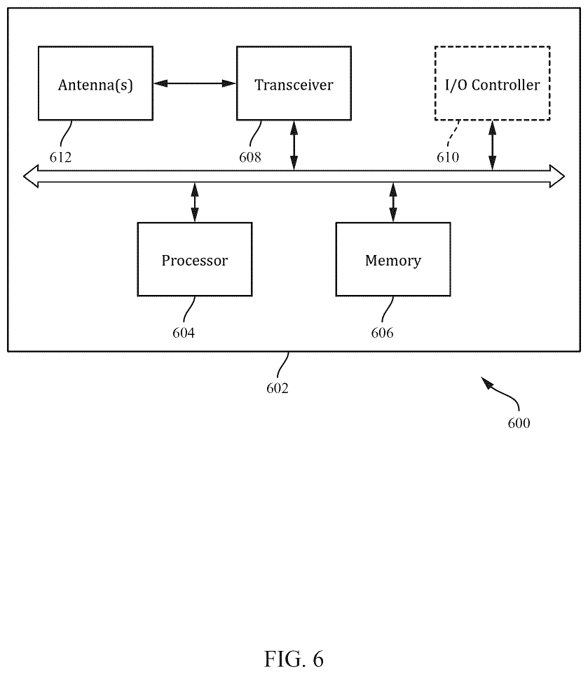

FIG. 6 illustrates an example of a block diagram 600 of a device 602 that supports adaptation of CSI (channel state information) feedback models in accordance with aspects of the present disclosure. The device 602 may be an example of a UE 104 as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. The processor 604 may be configured as or otherwise support a means for determining a first parameter for a model update of an AI/ML model trained to determine CSI feedback for a channel of a network, determining a first set of information including a first set of channel data representations during a first time-frequency-space region and a second set of information including a second set of channel data representations during a second time-frequency-space region, determining, based at least in part on the first set of information and the second set of information, a set of parameters for a first model, generating a third set of information based at least in part on the first model and a first data input to the first device, and transmitting the third set of information to a network entity.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor M06. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

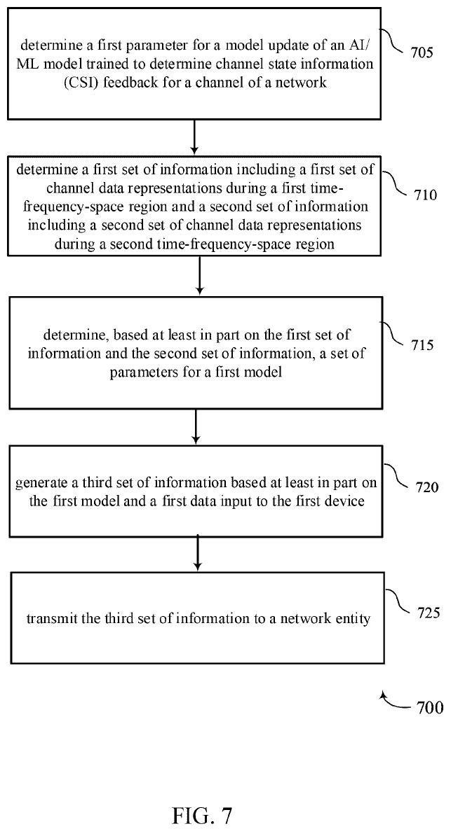

FIG. 7 illustrates a flowchart of a method 700 that supports updating an AI/ML model in accordance with aspects of the present disclosure. The operations of the method 700 may be implemented by a device or its components as described herein. For example, the operations of the method 700 may be performed by the UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 705, the method may include determining a first parameter for a model update of an AI/ML model trained to determine CSI feedback for a channel of a network. The operations of 705 may be performed in accordance with examples as described herein. In some implementations, aspects of the operations of 705 may be performed by a device as described with reference to FIG. 1.

At 710, the method may include determining a first set of information including a first set of channel data representations during a first time-frequency-space region and a second set of information including a second set of channel data representations during a second time-frequency-space region. The operations of 710 may be performed in accordance with examples as described herein. In some implementations, aspects of the operations of 710 may be performed by a device as described with reference to FIG. 1.

At 715, the method may include determining, based at least in part on the first set of information and the second set of information, a set of parameters for a first model. The operations of 715 may be performed in accordance with examples as described herein. In some implementations, aspects of the operations of 715 may be performed by a device as described with reference to FIG. 1.

At 720, the method may include generating a third set of information based at least in part on the first model and a first data input to the first device. The operations of 720 may be performed in accordance with examples as described herein. In some implementations, aspects of the operations of 720 may be performed by a device as described with reference to FIG. 1.

At 725, the method may include transmitting the third set of information to a network entity. The operations of 725 may be performed in accordance with examples as described herein. In some implementations, aspects of the operations of 725 may be performed by a device as described with reference to FIG. 1.

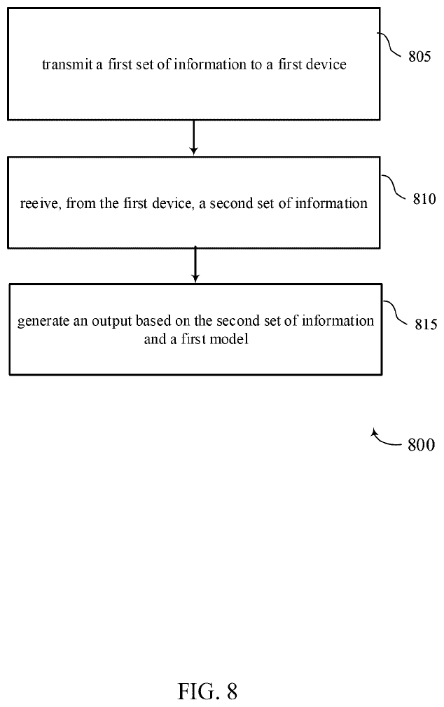

FIG. 8 illustrates a flowchart of a method 800 that supports generating CSI feedback using an updated AI/ML model in accordance with aspects of the present disclosure. The operations of the method 800 may be implemented by a device or its components as described herein. For example, the operations of the method 800 may be performed by the network entity 102 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 805, the method may include transmitting a first set of information to a first device. The operations of 805 may be performed in accordance with examples as described herein. In some implementations, aspects of the operations of 805 may be performed by a device as described with reference to FIG. 1.

At 810, the method may include receiving, from the first device, a second set of information. The operations of 810 may be performed in accordance with examples as described herein. In some implementations, aspects of the operations of 810 may be performed by a device as described with reference to FIG. 1.

At 815, the method may include generating an output based on the second set of information and a first model. The operations of 815 may be performed in accordance with examples as described herein. In some implementations, aspects of the operations of 815 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first device, comprising:
at least one memory; and
at least one processor coupled with the at least one memory and configured to cause the the first device to:
determine a first parameter for a model update of an artificial intelligence/machine learning (AI/ML) model trained to determine channel state information (CSI) feedback for a channel of a network;
determine a first set of information including a first set of channel data representations during a first time-frequency-space region and a second set of information including a second set of channel data representations during a second time-frequency-space region;
determine, based at least in part on the first set of information and the second set of information, a set of parameters for a first model;
generate a third set of information based at least in part on the first model and a first data input to the first device; and
transmit the third set of information to a network entity.

2. The first device of claim 1, wherein the first data input to the first device is based on a channel data representation, and wherein the channel data representation is based on different Tx-Rx pairs over:
different frequency bands,
different time slots, or
transformation of the different Tx-Rx pairs in a domain.

3. The first device of claim 1, wherein the first parameter includes a periodicity, and the set of parameters is periodically determined based on the periodicity.

4. The first device of claim 1, wherein the at least one processor is further configured to cause the first device to:
determine the first parameter based on a signal received from the network entity; and
determine the set of parameters in response to receiving the first parameter.

5. The first device of claim 1, wherein the at least one processor is further configured to cause the first device to determine the first parameter based on the first data or the first set of information and the second set of information.

6. The first device of claim 1, wherein the set of parameters includes a structure of a neural network or weights of a neural network.

7. The first device of claim 1, wherein the at least one processor is further configured to cause the first device to determine the set of parameters when an output of the first model based on the second set of information satisfies a similarity measure with respect to the first set of information.

8. The first device of claim 1, wherein the first set of information includes training data for training a two-sided model, and wherein the two-sided model includes a second model and a third model.

9. The first device of claim 8, wherein the at least one processor is further configured to cause the first device to determine the set of parameters when an output of the second model based on the first set of information satisfies a similarity measure with an output of a concatenated first model and second model based on the second set of information.

10. The first device of claim 8, wherein the similarity measure includes a statistical divergence measure that is lesser than a predetermined threshold.

11. The first device of claim 8, wherein the at least one processor is further configured to cause the first device to determine the first parameter based on the first model and the second model.

12. The first device of claim 1, wherein the first set of information is a training dataset and the second set of information is an observation dataset.

13. The first device of claim 1, wherein the third set of information is feedback CSI data generated by the AI/ML model and the first data is data measured by the first device and input to the AI/ML model.

14. The first device of claim 1, wherein the set of parameters for the first model include weights of an adaptation model of the AI/ML model.

15. The first device of claim 1, wherein the at least one processor is configured to cause the first device to determine the set of parameters for the first model in response to the first parameter satisfying criteria associated with performing the model update.

16. The first device of claim 1, wherein the first set of information is received from the network entity via network signaling.

17. A method performed by a first device, the method comprising:
determining a first parameter for a model update of an AI/ML (artificial intelligence/machine learning) model trained to determine channel state information (CSI) feedback for a channel of a network;
determining a first set of information including a first set of channel data representations during a first time-frequency-space region and a second set of information including a second set of channel data representations during a second time-frequency-space region;
determining, based at least in part on the first set of information and the second set of information, a set of parameters for a first model;
generating a third set of information based at least in part on the first model and a first data input to the first device; and
transmitting the third set of information to a second device.

18. A network entity, comprising:
at least one memory; and
at least one processor coupled with the at least one memory and configured to cause the network entity to:
transmit a first set of information to a first device;
receive, from the first device, a second set of information; and
generate an output based on the second set of information and a first model.

19. The network entity of claim 18, wherein the first set of information includes a set of channel data representations used for training a two-sided model that includes the first model and a second model.

20. A processor for wireless communication, comprising:
at least one controller coupled with at least one memory and configured to cause the processor to:
determine a first parameter for a model update of an AI/ML (artificial intelligence/machine learning) model trained to determine channel state information (CSI) feedback for a channel of a network;
determine a first set of information including a first set of channel data representations during a first time-frequency-space region and a second set of information including a second set of channel data representations during a second time-frequency-space region;
determine, based at least in part on the first set of information and the second set of information, a set of parameters for a first model;
generate a third set of information based at least in part on the first model and a first data input to the processor; and
transmit the third set of information to a network entity.
